(19) United States
(12) Patent Application Publication
(10) Pub. No.: US 2024/0375430 A1
(43) Pub. Date: Nov. 14, 2024

(54) VEHICLE WHEEL AND METHOD FOR PRODUCING SUCH A WHEEL

(71) Applicant: Maxion Wheels Holding GmbH, Königswinter (DE)

(72) Inventors: Adriano Phoenix Sant’Anna, Pocos de Caldas (BR); Rodrigo Leandro Gomes de Oliveira, Limeira (BR); Nicholas Spagnol, Limeira (BR); Marcelo Yomoto Graziani, Limeira (BR); Renato de Jesus Madeira, Vinhedo (BR); Peter Reh, Windeck (DE); Ralf Duning, Solingen (DE)

(73) Assignee: Maxion Wheels Holding GmbH, Königswinter (DE)

(21) Appl. No.: 18/144,317

(22) Filed: May 8, 2023

(51) Int. Cl. B60B 21/02; B60B 3/04; B60B 27/06

(52) U.S. Cl. CPC B60B 21/023; B60B 3/04; B60B 21/026; B60B 27/065; B60B 2310/20; B60B 2310/224

(57) ABSTRACT

A vehicle wheel includes an annular rim defining an axis and inboard and outboard sides. The rim includes an outboard bead seat, an inboard bead seat, an outboard well flank connected to the outboard bead seat and extending radially inwardly and towards the inboard side of the rim, and an inboard well flank connected to the inboard bead seat and extending radially inwardly and towards the outboard side of the rim. The rim further includes a well portion defined between the outboard and inboard well flanks, wherein the well portion is formed by a plurality of curved and straight portions linked together. The well portion has at least three transition portions having varying thickness cross-sectional profiles. A wheel disc is secured to the rim. The wheel disc includes a hub located centrally within the wheel disc and has a plurality of bolt holes formed therein.

### BACKGROUND OF THE INVENTION

The present invention relates in general to a vehicle wheel having a rim and wheel disc and in particular to an improved rim and method for producing such a rim.

Wheels for automotive vehicles may be formed by joining multiple components together. For example, a wheel may consist of two formed steel parts joined together, such as by welding. One known conventional wheel includes a generally planar or circular wheel disc welded to an outer circumferential edge portion of an annular rim. The rim has a suitable annular shape for receiving and supporting a tire mounted thereon. The wheel disc includes a central hub portion that functions as a wheel mounting portion of the wheel for connecting with an axle via a plurality of lug bolts and lug nuts.

It is known to produce a rim by first forming a steel blank into a hoop. The hoop can be further processed via a flow forming process and/or a rolling operation to form the profile shape of the rim. Flow forming is basically a metal-forming technique in which a metallic workpiece is formed over a mandrel by one or more rollers using pressure along the axial direction. The roller deforms the workpiece, forcing it against the mandrel, both axially lengthening and radially thinning it. Conventional rims which are made by flow forming generally have uniform surfaces on their inner and outer sides of the rim. Although such flow forming processes provide rims having sufficient rigidity, it would be desirable to produce a rim which optimizes the material usage of the rim for reducing the overall mass of the wheel disc and as well as minimizing stress levels during use of the wheel.

### SUMMARY OF THE INVENTION

The present invention relates to an improved vehicle wheel including a wheel disc and a rim and a method for producing such a rim and vehicle wheel as illustrated and/or described herein.

According to one embodiment, the wheel may comprise, individually and/or in combination, one or more of the following features, elements, or advantages: a vehicle wheel including an annular rim defining an axis and inboard and outboard sides, the rim including: an outboard bead seat; an inboard bead seat; an outboard well flank connected to the outboard bead seat and extending radially inwardly and towards the inboard side of the rim; an inboard well flank connected to the inboard bead seat and extending radially inwardly and towards the outboard side of the rim; and a well portion defined between the outboard and inboard well flanks, wherein the well portion is formed by a plurality of curved and straight portions linked together, wherein the well portion has at least three transition portions having varying thickness cross-sectional profiles; and a wheel disc secured to the rim, wherein the wheel disc includes a hub located centrally within the wheel disc and having a plurality of bolt holes formed therein.

According to this embodiment, the vehicle wheel is a commercial vehicle wheel.

According to this embodiment, the rim is produced by forming a metallic hoop.

According to this embodiment, the rim is formed into a final desired shape by a flow forming process.

According to this embodiment, the well portion has a first transition portion increasing in thickness in the direction from the outboard side to the inboard side.

According to this embodiment, the well portion includes a second transition portion decreasing in thickness in the direction from the outboard side to the inboard side.

According to this embodiment, the second transition portion includes a plurality of interconnected curved portions.

According to this embodiment, the well portion includes a straight cylindrical portion disposed between the first and second transition portions.

According to this embodiment, the well portion includes a third transition portion increasing in thickness in the direction from the outboard side to the inboard side.

According to this embodiment, the well portion includes a curved portion disposed between the second and third transition portions.

According to this embodiment, the well portion includes a fourth transition portion decreasing in thickness in the direction from the outboard side to the inboard side.

According to this embodiment, the fourth transition portion has a curved shape.

According to another embodiment, the wheel may comprise, individually and/or in combination, one or more of the following features, elements, or advantages: a commercial vehicle wheel including a wheel disc secured to the rim, wherein the wheel disc includes a hub located centrally within the wheel disc and having a plurality of bolt holes formed therein; and an annular rim secured to the disc, wherein the rim defines an axis and inboard and outboard sides, the rim including: an outboard bead seat; an inboard bead seat; an outboard well flank connected to the outboard bead seat and extending radially inwardly and towards the inboard side of the rim; an inboard well flank connected to the inboard bead seat and extending radially inwardly and towards the outboard side of the rim; and a well portion defined between the outboard and inboard well flanks, wherein the well portion includes: a first transition portion increasing in thickness in the direction from the outboard side to the inboard side; a second transition portion decreasing in thickness in the direction from the outboard side to the inboard side; a straight cylindrical portion disposed between the first and second portions; a third transition portion increasing in thickness in the direction from the outboard side to the inboard side; a curved portion disposed between the second and third transition portions; a fourth transition portion decreasing in thickness in the direction from the outboard side to the inboard side.

According to this embodiment, the second transition portion includes a plurality of interconnected curved portions.

According to this embodiment, the fourth transition portion has a curved shape.

According to another embodiment, a method for producing a wheel rim for a wheel may comprise, individually and/or in combination, one or more of the following steps, features, elements, or advantages: (a) providing a blank; (b) forming the blank into a hoop defining a cylindrically shaped inner surface and a cylindrically shaped outer surface; (c) flow forming one of the inner and outer surfaces of the hoop to create at least three transition portions having a varying thickness cross-sectional profile; and (d) subsequently to step (c), performing at least one rolling operation on the hoop to form an outboard bead seat, an outboard well flank, an inboard bead seat, an inboard well flank, and a contoured well portion disposed between the outboard and inboard well flanks, wherein the well portion includes at least three transition portions having varying thickness cross-sectional profiles derived from the flow forming process of step (c), thereby forming the wheel rim.

According to this embodiment, method may further comprise the steps of: (e) providing a wheel disc having a hub located centrally within the wheel disc and having a plurality of bolt holes formed therein; and (f) securing the wheel disc to the wheel rim.

According to this embodiment, in step (c) a flow forming operation is performed on the outer surface of the hoop to form a plurality of transition points where changes in the thickness of the hoop occur.

According to this embodiment, the hoop defines an outboard side and an inboard side, and wherein in step (c) the flow forming operation performed on the outer surface of the hoop forms a plurality of first portions having a decreasing thickness in the direction from the outboard side to the inboard side.

According to this embodiment, the flow forming operation performed on the outer surface of the hoop forms a plurality of second portions having an increasing thickness in the direction from the outboard side to the inboard side.

According to another embodiment, a method for producing a vehicle wheel may comprise, individually and/or in combination, one or more of the following steps, features, elements, or advantages: (a) providing a blank; (b) forming the blank into a hoop defining a cylindrically shaped inner surface and a cylindrically shaped outer surface, wherein the hoop defines an outboard side and an inboard side; (c) flow forming the outer surface of the hoop to form a plurality of transition points where changes in the thickness of the hoop occur such that the flow forming forms a plurality of first portions having a decreasing thickness in the direction from the outboard side to the inboard side, and forms a plurality of second portions having an increasing thickness in the direction from the outboard side to the inboard side; (d) subsequently to step (c), performing at least one rolling operation on the hoop to form an outboard bead seat, an outboard well flank, an inboard bead seat, an inboard well flank, and a contoured well portion disposed between the outboard and inboard well flanks, wherein the wheel well portion includes transition portions having varying cross-sectional profiles derived from the flow forming process of step (c); (e) providing a wheel disc; and (f) securing the wheel disc to the wheel rim, thereby forming the vehicle wheel.

Various aspects of this invention will become apparent to those skilled in the art from the following detailed description of the preferred embodiments, when read in light of the accompanying drawings.

### BRIEF DESCRIPTION OF THE DRAWINGS

FIG. 1 is a front perspective view of a vehicle wheel in accordance with the present invention.

FIG. 2 is a front elevational view of the vehicle wheel of FIG. 1.

FIG. 3 is cross-sectional view of the vehicle wheel taken along lines 3-3 in FIG. 2.

FIG. 4 is a front elevational view the rim of the vehicle wheel of FIG. 1.

FIG. 5 is an enlarged partial cross-sectional view of the rim taken along lines 5-5 in FIG. 4.

FIG. 6 is an enlarged partial cross-sectional view of the rim similar to that shown in FIG. 5 with additional dimensional references used in the figure.

FIG. 7 is a schematical cross-sectional view of a portion of a blank hoop used to form a rim of the vehicle wheel of FIG. 1.

FIG. 8 is a schematical cross-sectional view of the portion of the hoop in FIG. 4 that has undergone a flow forming operation providing a cross-sectional profile having varying thicknesses.

FIG. 9 is a flow chart summarizing the process of forming the rim of the vehicle wheel of FIG. 1.

### DETAILED DESCRIPTION OF THE PREFERRED EMBODIMENTS

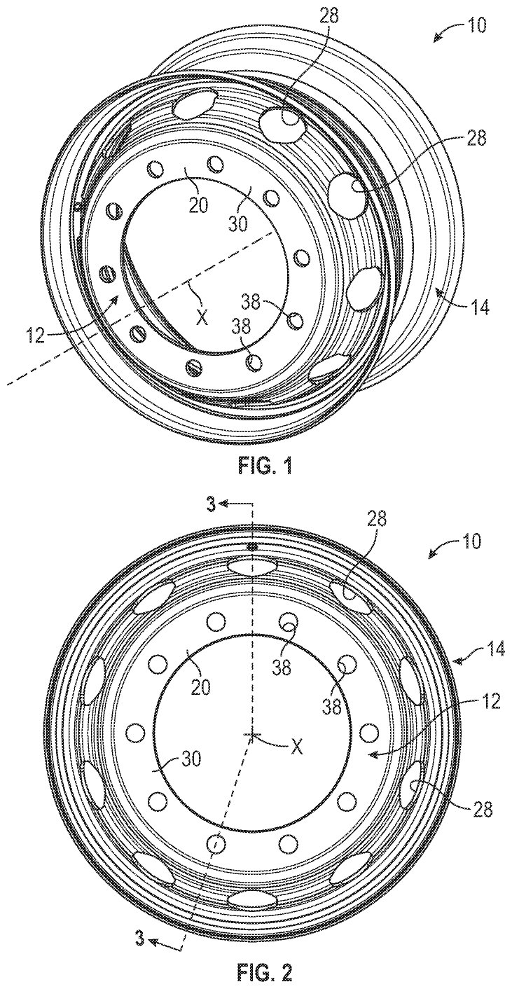

Referring now to the drawings, there is illustrated in FIGS. 1-3, a vehicle wheel, indicated generally at 10. The vehicle wheel 10 is preferably a commercial vehicle wheel type which is used for relatively large and heavy-duty commercial vehicles, such as trucks. The vehicle wheel 10 generally incudes a wheel disc, indicated generally at 12, and an annular outer wheel rim, indicated generally at 14. Although the invention is illustrated and described in conjunction with the particular vehicle wheel construction disclosed herein, it will be appreciated that the invention can be used in conjunction with other types of vehicle wheel constructions.

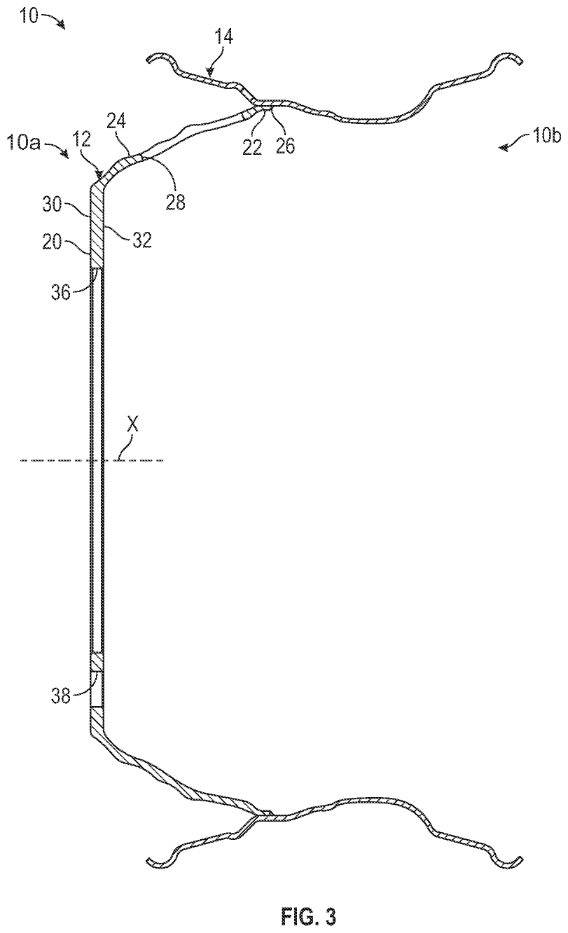

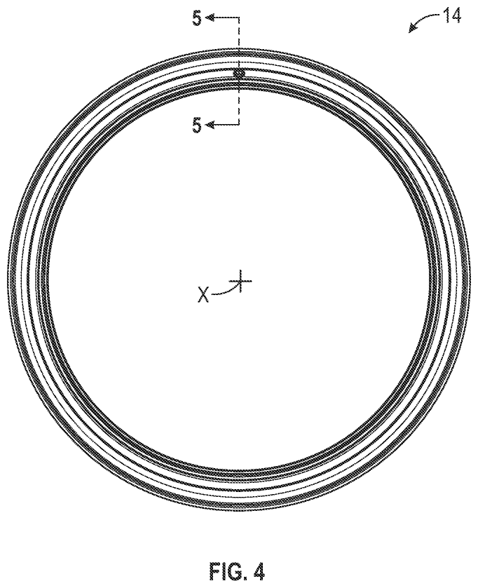

The wheel 10 can be generally described as having a front or an outboard side, indicated generally at 10a, on the left-hand side as viewing FIG. 3. The wheel 10 has a rear of an inboard side, indicated generally at 10b, on the right-hand side as viewing FIG. 3. When mounted on the vehicle, the wheel disc 12 is generally on the outboard side 10a.

In a preferred embodiment (and as illustrated herein), the wheel disc 12 and the wheel rim 14 are produced separately and then joined together by any suitable means, such as by welding, to produce a fabricated vehicle wheel 10. In a preferred embodiment, the wheel disc 12 and the wheel rim 14 are made from steel and are then welded together to form the wheel 10. Of course, the wheel disc 12 and/or the wheel rim 14 may be made of any suitable materials such as for example, aluminum, magnesium, titanium, or alloys thereof, carbon fiber and/or composite materials and/or may be secured together by other suitable means, if so desired.

The combination of the annularly shaped wheel disc 12 and the wheel rim 14 defines a wheel axis X for the wheel 10. Referring to FIG. 3, the wheel disc 12 generally includes a centrally located hub, indicated generally at 20, an outer circumferential edge 22, and an annular disc body portion, indicated generally at 24. The hub 20 may preferably have a relatively flat circular shape and is generally defined as the central portion of the wheel disc 12. The outer circumferential edge 22 of the wheel disc 12 includes a circular flange 26 which is welded (or otherwise attached) to a bead seat portion of the rim 14, as will be discussed below.

The disc body portion 24 is generally annulus or ring-shaped and encircles the hub 20. The disc body portion 24 radially extends between the hub 20 and the outer circumferential edge 22. The disc body portion 24 preferably includes a plurality of ventilation holes 28 formed therein. The vent holes 28 not only provide ventilation for wheel brakes (not shown) mounted adjacent to the wheel 10 but also help in reducing the overall weight or mass of the wheel 10. The disc body portion 24 can have any number of ventilation holes 28 formed therein having any suitable shape. Alternatively, the disc body portion 24 can be formed with a plurality of spokes (not shown) radially extending between the hub 20 and the outer circumferential edge 22.

In the illustrated embodiment shown in FIG. 3, the hub 20 has a front face or surface 30, and a rear face or surface 32. The front surface 30 is located on the outboard side 10a of the wheel 10 and faces the outboard side 10a when mounted on a vehicle. The rear surface 32 generally faces towards the inboard side 10b of the wheel 10. The hub 20 functions as a wheel mounting portion or center mounting portion of the wheel 10 for connecting with an axle (not shown) via a plurality of lug bolts (not shown) and lug nuts (not shown).

The hub 20 includes a centrally located hub hole 36. The hub hole 36 extends through and about the wheel axis X. The hub hole 36 may accommodate a portion of the axle. The hub hole 36 may have any suitable diameter. A plurality of lug bolt receiving holes 38 are formed in the hub 20 and are circumferentially spaced around the hub hole 36 and the wheel axis X. For example, the hub 20 may include five lug bolt receiving holes 38. Alternatively, the number and/or location of the lug bolt receiving holes 38 may be other than illustrated if so desired. The lug bolt receiving holes 38 receive the lug bolts (not shown) for securing the vehicle wheel 10 with lug nuts (not shown) on the axle of an associated vehicle.

In a preferred embodiment, the wheel disc 12 is preferably produced from a single steel blank (not shown) which is then formed by suitable means to form the wheel disc 12. The blank may be first provided as a smooth, flat annular or ring-shaped steel disc blank, and then preferably shaped such as by a flow forming process or rolling process into the final wheel disc shape. Alternatively, the blank may be formed by any suitable means, such as stamping and/or flow forming, into a wheel disc “preform” (not shown) having a particular partially formed wheel disc shape before it is formed into the final wheel disc shape, preferably by flow forming.

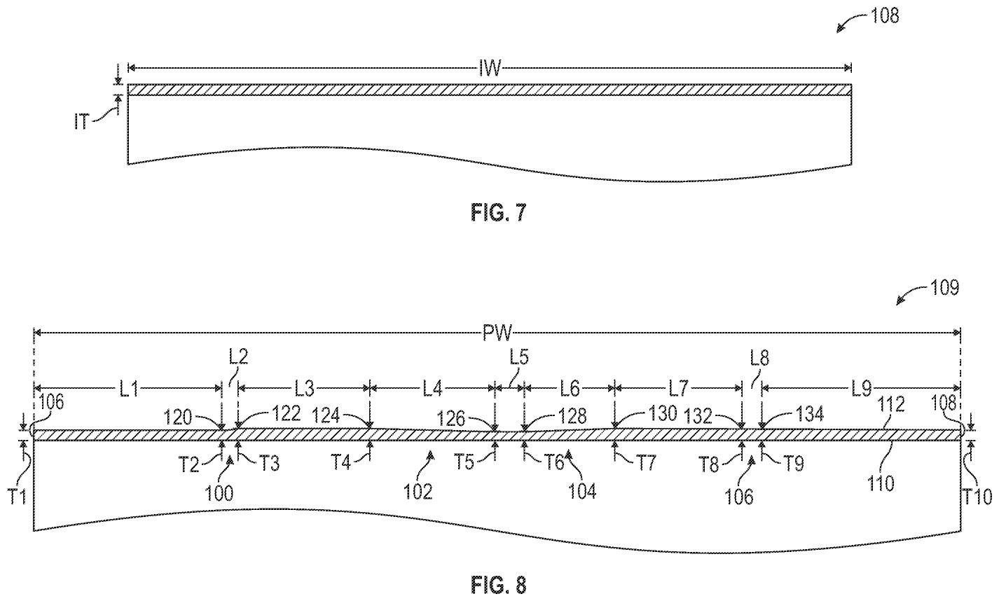

The wheel rim 14 can have any suitable annular shape for receiving and supporting a tire (not shown). The wheel rim 14 preferably has a continuous annular shape relative to the wheel axis X for accommodating a vehicle tire (not shown) mounted thereon. As will be described in further detail below, the wheel rim 14 of the present invention is manufactured by first forming a cylindrical blank hoop (FIG. 7) into a pre-production hoop (FIG. 8) having a plurality of transition portions formed therein having varying cross-sectional thicknesses. As will be explained below, the initial formation of the hoop having varying cross-sectional thicknesses will help define and form portions of a well portion of the rim 14 having these varying cross-sectional thicknesses.

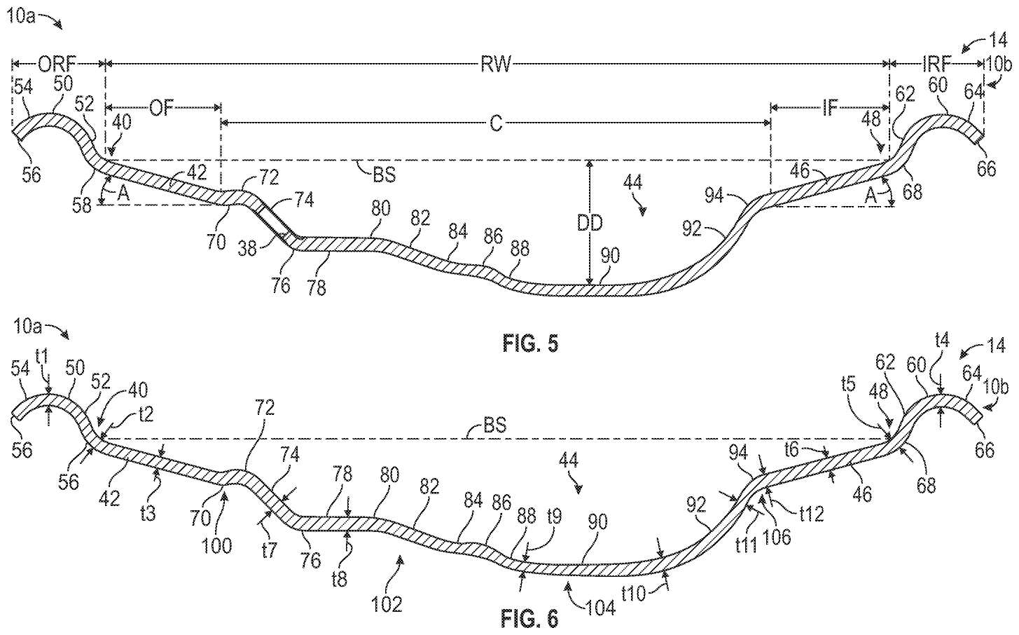

Referring now to the schematic cross-section illustration of FIGS. 5 and 6, the rim 14 generally includes an outboard bead seat, indicated generally at 40, an outboard well flank 42, a drop center base or well portion 44, an inboard well flank 46, and an inboard bead seat, indicated generally at 48. The outboard bead seat 40 is connected to the outboard well flank 42. Similarly, the inboard bead seat 48 is connected to the inboard well flank 46. The well portion 44 is disposed between the outboard and the inboard well flanks 42 and 46. The well flanks 42 and 46 may be formed as frustoconical portions having a non-curved profile formed at the same angle A relative to the wheel axis X. In a preferred embodiment as shown in FIG. 5, the angle A is about 15 degrees.

Note that the portion of the rim 14 illustrated in FIG. 6 is essentially identical to the portion of the rim 14 illustrated in FIG. 5 with the exception of a lack of the bolt receiving hole 38 which has been removed for clarity purposes. The duplication of FIG. 6 has been added to provide an additional figure so as to avoid confusion of the relatively large amount of reference numbers and dimensional referencing labeled on the rim 14. It should also be understood that the drawing figures herein schematically represent the wheel 10 of the present invention and are not necessarily drawn to scale, drawn to scale relative to one another, and/or may have exaggerated dimensions to assist in clarity and understanding of the drawings.

In general, the outboard bead seat 40, the outboard well flank 42, the inboard well flank 46, and the inboard bead seat 48 are formed with a standard profile commonly used in the industry to accommodate the proper mounting of various tires used in the marketplace. Although the thickness of the rim 14 at these outboard and inboard portions may be generally constant, in a preferred embodiment of the invention, the thicknesses of the outboard bead seat 40 and the outboard well flank 42 are different than the thicknesses of the inboard bead seat 48 and the inboard well flank 46, respectively, as will be discussed in detail below. As will also be discussed in detail below, the well portion 44 is manufactured with portions have varying thicknesses across its length. The varying thickness portions of the well portion 44 are specifically designed and produced to provide structural advantages for the rim 14. For example, the overall weight of the wheel 10 can be reduced with providing portions of the rim 14 with reduced thicknesses at areas wherein the mass and structural rigidity may not be required compared to commercially available prior art wheels having the same cross-sectional thickness across the entire length of the rim 14. The unique profile shape of the rim 14 having various straight and curved portions may also help to reduce stress levels within the rim 14. These advantages can be obtained by the specific geometry of the illustrated well portion 44.

The structural details of the final produced rim 14 will now be explained with respect to FIGS. 5 and 6. The outboard bead seat 40 and the inboard bead seat 48 provide a mounting and contacting surface for sealing with a tire (not shown) mounted on the wheel 10. A broken line, indicated generally by BS, schematically represents the bead seat diameter or inner diameter portion of a tire that is mounted on the wheel 10. The conventionally known “rim width” may be determined as the axial distance between the bead seats 40 and 48. This rim width is labelled as RW in FIG. 5. In a preferred embodiment, the rim width RW is within the range of about 133.5 millimeters to about 457 millimeters. In a more preferred embodiment and illustrated in the Figures, the rim width RW is about 230 millimeters.

The wheel diameter is generally the radial diameter of the respective bead seats 40 and 48. It should be appreciated that the rim 14 can have any desired diameter and/or shape. The wheel 10 can be manufactured to any suitable size for mounting a tire thereon. Tire sizes for conventional commercial vehicles are generally within the range of about 444.5 millimeters to about 673.1 millimeters, for example. In a preferred embodiment and illustrated in the Figures, the rim 14 has an outer diameter or a wheel diameter of about 570 mm.

Adjacent to the outboard bead seat 40 is an outboard bead seat retaining flange 50 connected to the outboard bead seat 40. The outboard bead seat retaining flange 50 generally has an axial width ORF. In a preferred embodiment, the axial width ORF of the outboard bead seat retaining flange 50 is within the range of about 15.8 millimeters to about 29 millimeters. In a more preferred embodiment and illustrated in the Figures, the axial width ORF is about 23 millimeters. The outboard bead seat retaining flange 50 generally provides for lateral or axial support of the tire mounted on the wheel 10. The outboard bead seat retaining flange 50 includes a sidewall 52 and a curled lip portion 54 ending in an outer edge 56. The sidewall 52 may be smoothly connected with the outboard bead seat 40 by a curved portion 58. The curved portion 58 is connected to the outboard well flank 42. The outboard well flank 42 generally extends radially inwardly and in a direction towards the outboard side 10b. As stated above, the outboard well flank 42 may have a generally frustoconical shape about the wheel axis X. The outboard well flank 42 has an axial width OF. In a preferred embodiment, the axial width OF of the outboard well flank 42 is within the range of about 25 millimeters to about 40 millimeters. In a more preferred embodiment and illustrated in the Figures, the axial width OF is about 36 millimeters.

The inboard side 10b of the rim 14 is similar in structure as the outboard side 10a. Adjacent to the inboard bead seat 48 is an inboard bead seat retaining flange 60 connected to the inboard bead seat 40. The inboard bead seat retaining flange 60 generally has an axial width IRF. In a preferred embodiment, the axial width IRF of the inboard bead seat retaining flange 60 is within the range of about 15.8 millimeters to about 29 millimeters. In a more preferred embodiment and illustrated in the Figures, the axial width IRF is about 23 millimeters. The inboard bead seat retaining flange 60 generally provides for lateral or axial support of the tire mounted on the wheel 10. The inboard bead seat retaining flange 60 includes a sidewall 62 and a curled lip portion 64 ending in an outer edge 66. The sidewall 62 may be smoothly connected with the inboard bead seat 48 by a curved portion 68. The curved portion 68 is connected to the inboard well flank 46. The inboard well flank 46 generally extends radially inwardly and in a direction towards the inboard side 10a. As stated above, the inboard well flank 46 may have a generally frustoconical shape about the wheel axis X. The inboard well flank 46 has an axial width IF. In a preferred embodiment, the axial width IF of the inboard well flank 46 is within the range of about 25 millimeters to about 40 millimeters. In a more preferred embodiment and illustrated in the Figures, the axial width IF is about 36 millimeters.

The tire well portion 44 generally defines the cavity or open region between the bead seats 40 and 48. The well portion 44 may be defined as the open region generally radially inwardly from (or below as viewing FIGS. 5 and 6) the bead seat diameter BS. The well portion 44 has a maximum depth DD. In a preferred embodiment, the depth DD is within the range of about 30 millimeters to about 40 millimeters. In a more preferred embodiment and illustrated in the Figures, the depth DD is about 36 millimeters. The well portion 44 has an axial width C. In a preferred embodiment, the axial width C is within the range of about 83.5 millimeters to about 389 millimeters. In a more preferred embodiment, the axial width C is about 158 millimeters.

As stated above, the well portion 44 generally extends between the outboard and inboard well flanks 42 and 46. The well portion 44 has a varying profile shape and is generally formed from a plurality of curved and straight portions linked together, as can be seen in FIGS. 5 and 6. The varying shaped cross-sectional profile of the well portion 44 provides rigidity to the rim 14 compared to a smooth profile shape. As will be explained below, the thicknesses at various portions of the well portion may also be thinned to reduce weight of the rim 14. Although the rim 14 illustrated in FIGS. 5 and 6 illustrate a preferred embodiment, it should be understood that the well portion 44 may be formed from other various curved and straight portions and not necessary as exactly illustrated in FIGS. 5 and 6.

The structural details of a preferred embodiment of the well portion 44 will now be discussed. In general, the structural details will be described as portions being connected together starting from the outboard side 10a of the well portion 44 and moving toward the inboard side 10b (or towards the right as viewing FIGS. 5 and 6). The outboard side of the well portion 44 includes a concave outboard curved portion 70 which connects the well portion 44 to the outboard well flank 42. The outboard curved portion 70 is relatively small and may correspond to one the varying thickness portions, as will be described below. The terms “concave” and “convex” as used herein with respect to the well portion 44 define the orientation of the curves relative to the wheel axis. For example, a concave curve curves radially inwardly towards the wheel axis X such that the center point of the radius forming the curve is positioned radially outwardly (above when viewing FIGS. 5 and 6) from the respective curve. A convex curve curves radially outwardly towards the wheel axis X such that the center point of the radius forming the curve is positioned radially inwardly (below when viewing FIGS. 5 and 6) from the respective curve.

The outboard curved portion 70 is connected to a convex curved portion 72. The curved portion 72 is connected with a frustoconical bolt hole portion 74 which receives the plurality of lug bolt receiving holes 38, as shown in FIG. 5. The bolt hole portion 74 may be flat such that there are no curves formed in the frustoconically shaped portion. The bolt hole portion 74 is connected to a concave curved portion 76 which connects to a straight portion 78. The straight portion 78 may have a cylindrical shape, as shown in FIGS. 5 and 6, such that a surface of the straight portion 78 is parallel with the wheel axis X. The term “straight” as used herein with respect to the well portion 44 relates to a portion not having curves formed therein. The straight portion may be frustoconical in shape (such as the outboard well flank 42 or the bolt hole portion 74) or may be cylindrical in shape (such as the straight portion 78). The straight portion 78 is connected with a curved portion 80 which is in turn connected to an inclined portion 82. The other end of the inclined portion 82 is connected with a slight concave curved portion 84 which is connected to a convex curved portion 86 which is in turn connected to a relatively small concave portion 88. The concave portion 88 is connected to a relatively large radius concave curved portion 90 which is connected to a concave curved portion 92. In a preferred embodiment, the radius forming the curved portion 90 is larger than the curved portion 92. The other end of the curved portion 92 is connected with a convex curved portion 94 which is connected to the inboard well flank 46. As stated above, the well portion 44 of the rim 14 may be formed from other various curved and straight portions and not necessary as exactly illustrated in FIGS. 5 and 6.

The structural details of the varying thicknesses of the final formed rim

14 will now be described. As will be discussed below, the varying thicknesses of the rim 14 generally correspond to the process of forming the rim 14 by first using a blank or hoop, as shown in FIG. 8, having varying thickness. The hoop undergoes a forming process to manufacture the rim 14 to its final shape as illustrated in FIGS. 5 and 6.

As shown in FIG. 6, the outboard bead seat retaining flange 50 has a thickness t1. The curved portion 58 of the outboard bead seat 40 has a thickness t2. The outboard well flank 42 has a thickness t3. In a preferred embodiment, the thicknesses t1, t2, and t3 are generally the same. Thus, the outboard side of the rim 14 has a generally constant thickness in the preferred embodiment. Of course, the thicknesses t1, t2, and t3 need not be the same if so desired.

The inboard bead seat retaining flange 60 has a thickness t4. The curved portion 68 of the inboard bead seat 48 has a thickness t5. The inboard well flank has a thickness t6. In a preferred embodiment, the thicknesses t4, t5, and t6 are generally the same. Thus, the inboard side of the rim 14 has a generally constant thickness in the preferred embodiment. Of course, the thicknesses t4, t5, and t6 need not be the same if so desired. Although the thicknesses of the inboard and outboard sides of the rim may be the same, in the preferred embodiment of the rim 14 illustrated in FIGS. 5 and 6, the inboard side of the rim 14 is greater than the thickness of the outboard side. Thus, the thicknesses t1, t2, and t3 are less than the thicknesses of t4, t5, and t6. This may be desirable due to the outboard side of the rim 14 being physically connected to the wheel disc 12 in a closer manner than the inboard side of the rim 14. This closer connection may provide a greater rigidity to the outboard side of the rim 14 compared to the inboard side, thereby permitting the thickness to be reduced at the outboard side to reduce the weight of the wheel 10.

In a preferred embodiment, the thicknesses t1, t2, and t3 are within the range of about 2.5 millimeters to about 6.75 millimeters. In a more preferred embodiment and illustrated in the Figures, the thicknesses of t1, t2, and t3 are about 3.3 millimeters. In a preferred embodiment, the thicknesses t4, t5, and t6 are within the range of about 2.75 millimeters to about 7.3 millimeters. In a more preferred embodiment and illustrated in the Figures, the thicknesses of t1, t2, and t3 are about 3.55 millimeters.

The well portion 44 is preferably formed with portions have varying thicknesses, as mentioned above, which will be described as “transition” portions. In the illustrated embodiment of FIGS. 5 and 6, the well portion 44 has four transition portions 100, 102, 104, and 106. The transition portion 100 is generally located about the concave curved portion 70. Preferably, the transition portion 100 reduces the thickness from the thickness t7 located at the bolt hole portion 74 to the thickness t3 of the outboard well flank 42. In a preferred embodiment, the thickness t7 is within the range of about 3 millimeters to about 8 millimeters. In a more preferred embodiment and illustrated in the Figures, the thickness t7 is about 3.9 millimeters. A thickness t8 located at the straight portion 78 is preferably the same as the thickness t7.

The transition portion 102 is generally located about the curved portion 80, the inclined portion 82, and the curved portion 86. Preferably, the transition portion 102 decreases the thickness from the straight portion 78 towards the curved portion 86. As such, a thickness 19 located at the curved portion 88 is preferably less than the thickness t8. In a preferred embodiment, the thickness t9 is within the range of about 2.15 millimeters to about 6 millimeters. In a more preferred embodiment and illustrated in the Figures, the thickness t9 is about 2.8 millimeters.

The transition portion 104 is generally located about the curved portion 90. Preferably, the transition portion 104 increases the thickness of the curved portion 90 towards the curved portion 92. As shown in FIG. 6, a thickness t10 located about at the junction of the curved portions 90 and 92 is greater than the thickness t9. In a preferred embodiment, the thickness t10 is within the range of about 2.85 millimeters to about 7.6 millimeters. In a more preferred embodiment and illustrated in the Figures, the thickness t10 is about 3.7 millimeters.

The transition portion 106 is generally located about the curved portion 94. Preferably, the transition portion 106 decreases the thickness of the curved portion 94 in the direction towards the inboard side of the rim 14. As shown in FIG. 6, a thickness t11 is located generally on one end of the curved portion 94, and a thickness t12 is generally located on the other end of the curved portion 94. In the preferred embodiment, the thickness t11 is greater than the thickness t12. In a preferred embodiment, the thickness t11 is within the range of about 3.5 millimeters to about 6.2 millimeters. In a more preferred embodiment and illustrated in the Figures, the thickness t11 is about 3.7 millimeters. Note that the preferred thicknesses of t10 and t11 are the same. In a preferred embodiment, the thickness t12 is within the range of about 2.75 millimeters to about 7.3 millimeters. In a more preferred embodiment and illustrated in the Figures, the thickness t12 is about 3.55 millimeters. Note that the preferred thickness of t12 is the same as the thicknesses t4, t5, and t6 on the inboard side of the rim 14.

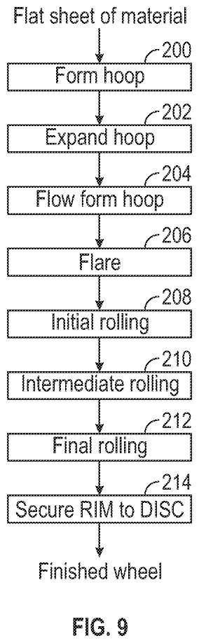

The rim 14 may be manufactured by any suitable method. In a preferred method, the rim 14 is at least partially formed by a rolling and forming process to obtain the desired annular shape, as shown in FIGS. 5 and 6. Suitable methods of producing a vehicle rim are described in U.S. Pat. Nos. 5,579,578 and 4,962,587 both of which are incorporated by reference herein. There is illustrated in FIG. 9 a block diagram showing a sequence of steps of a suitable method for producing the rim 14. Initially, a flat sheet of suitable material or blank, such as for example, steel or aluminum, is provided. In a preferred embodiment, the sheet of material is provided having a constant thickness across its length. In step 200 of FIG. 9, the sheet of material is formed into a generally cylindrical band or hoop wherein the ends are welded together, thereby forming the hoop. FIG. 7 represents a cross-sectional portion of the initial hoop, indicated generally at 100. As shown in FIG. 7, the initial hoop 108 has an initial width IW and a constant cross-sectional thickness IT. In a preferred embodiment, the width IW is within the range of about 184 millimeters to about 540 millimeters. In a more preferred embodiment and illustrated in the Figures, the width IW is about 268 millimeters. In a preferred embodiment, the thickness IT is within the range of about 3 millimeters to about 8 millimeters. In a more preferred embodiment and illustrated in the Figures, the thickness IT is about 3.9 millimeters.

When the initial hoop 108 is welded in step 200 of FIG. 9, a flat surface may be created by the weld where the two ends meet. As a result of this, the initial hoop 108 may optionally be expanded in step 202 to produce a substantially cylindrical initial hoop 108.

The initial hoop 108 is then preferably subjected to a flow forming process in step 204 to produce a preform hoop 109, as represented in FIG. 8. As shown in FIG. 8, the preform hoop 109 is flow formed into a hoop shape having a contoured cross-sectional profile such that the preform hoop 109 has varying thicknesses across its width. In a preferred embodiment, an inner surface 110 of the preform hoop 109 remains flat (no curves) having a flat cylindrical shape. An outer surface 112 of the preform hoop 109 is preferably shaped by the flow forming process to provide the contoured shape as shown in FIG. 8. Of course, if desired the inner surface 110 may be contoured instead of the outer surface, or both of the surfaces 110 and 112 may be both formed having a contoured shape. In the flow forming process, the initial hoop 108 is formed over a mandrel by one or more rollers using pressure along the axial direction. The roller deforms at least portions of the outer surface of the initial hoop 108, forcing it against the mandrel, both axially lengthening and radially thinning it to form the preform 102 of FIG. 8.

After the flow forming operation of the step 204 of FIG. 9, the preform hoop 109 of FIG. 8 is formed. The structural details of the preform hoop 109 will now be discussed. In general, the structural details will be described as portions changing thickness starting from the outboard side and moving toward the inboard side (or towards the right as viewing FIG. 8).

In a preferred embodiment, the flow forming operation will increase the width of the preform hoop 109 relative to the initial hoop 108. The preform hoop 109 has a width PW which is greater than the width IW of the initial hoop 108. In a preferred embodiment, the width PW is within the range of about 213 millimeters to about 525 millimeters. In a more preferred embodiment and illustrated in the Figures, the width PW is about 304 millimeters. The width PW extends between an outboard end 106 and an inboard end 108 of the preform hoop 109.

The preform hoop 109 includes a plurality of transition points on its outer surface 112 along its width where thickness changes occur. In the preferred embodiment as shown in FIG. 8, there are eight transition points 120, 122, 124, 126, 128, 130, 132, and 134. As shown in FIG. 8, the preform hoop 109 has a thickness T1 at the outboard end 106, and a thickness T2 at the transition point 120. In the preferred embodiment, the thicknesses TI and T2 are the same such that the portion of the preform hoop 109 between outboard end 106 and the transition point 120 is relatively flat or parallel with the axis of the hoop 109. In the preferred embodiment and illustrated in the Figures, the thicknesses T1 and T2 are about 3.3 millimeters.

In a preferred embodiment, the thickness increases from the transition point 120 to the transition point 122. The transition point 122 has a thickness T3. In the preferred embodiment and illustrated in the Figures, the thickness T3 is about 3.9 millimeters. Preferably, the cross-sectional profile remains flat between the transition points 122 and 124 located at the transition point 124. Thus, in the preferred embodiment and illustrated in the Figures, the thickness T4 is about 3.9 millimeters.

In a preferred embodiment, the thickness decreases from the transition point 124 to the transition point 126. The transition point 126 has a thickness T5. In the preferred embodiment and illustrated in the Figures, the thickness T5 is about 2.8 millimeters. Preferably, the cross-sectional profile remains flat between the transition points 126 and 128 located at the transition point 128. Thus, in the preferred embodiment and illustrated in the Figures, the thickness T6 is about 2.8 millimeters.

In a preferred embodiment, the thickness increases from the transition point 128 to the transition point 130. The transition point 130 has a thickness T7. In the preferred embodiment and illustrated in the Figures, the thickness T7 is about 3.7 millimeters. Preferably, the cross-sectional profile remains flat between the transition points 130 and 132 located at the transition point 132. Thus, in the preferred embodiment and illustrated in the Figures, the thickness T8 is about 3.7 millimeters.

In a preferred embodiment, the thickness decreases slightly from the transition point 132 to the transition point 134. The transition point 134 has a thickness T9. In the preferred embodiment and illustrated in the Figures, the thickness T9 is about 3.55 millimeters. Preferably, the cross-sectional profile remains flat between the transition point 134 and the inboard end 108. The inboard end has a thickness T10. Thus, in the preferred embodiment and illustrated in the Figures, the thickness T10 is about 3.55 millimeters.

It should be understood that any number of transition points may be formed in accordance with the present invention and may have less or more than those shown in the illustrated embodiment. The transition points may be spaced across the width of the preform hoop 109 by any suitable manner. In the illustrated embodiment, as shown in FIG. 6, the transition point 120 is spaced from the outboard end 106 by a length L1. The transition point 122 is spaced from the transition point 120 by a length L2. The transition point 124 is spaced from the transition point 122 by a length L3. The transition point 126 is spaced from the transition point 124 by a length L4. The transition point 128 is spaced from the transition point 126 by a length L5. The transition point 130 is spaced from the transition point 128 by a length L6. The transition point 132 is spaced from the transition point 130 by a length L7. The transition point 134 is spaced from the transition point 132 by a length L8. The inboard end 108 is spaced from the transition point 134 by a length L9. In the preferred embodiment and illustrated in the Figures, the length L1 is about 63.15 millimeters, the length L2 is about 4.4 millimeters, the length L3 is about 42.3 millimeters, the length L4 is about 41.4 millimeters, the length L5 is about 9.0 millimeters, the length L6 is about 30.5 millimeters, the length L7 is about 38.5 millimeters, the length L8 is about 6.7 millimeters, and the length L9 is about 68.05 millimeters.

The well portion 44 was described above as having four transition portions 100, 102, 104, and 106 where portions of the well portion 44 have varying thicknesses. During the flow forming operation of step 204, these transition portions stem from or are produced as the result of initially having these differing thicknesses formed on the preform hoop 109. The transition portions 100, 102, 104, and 106 are labelled in FIG. 6. The transition portion 100 generally corresponds to the increase in thickness from the transition point 120 to the transition point 122. The transition portion 102 generally corresponds to the decreases in thickness from the transition point 124 to the transition point 126. The transition portion 104 generally corresponds to the increase in thickness from the transition point 128 to the transition point 130. The transition portion 106 generally corresponds to the slight decrease in thickness from the transition point 132 to the transition point 134.

Referring again to FIG. 9, the outboard and inboard end portions of the preform hoop 109 are then flared in an optional step 206 to generally form the outboard and inboard portions of the rim 14. For example, this optional flare step 206 may be used to form the outboard bead seat retaining flange 50, the outboard bead seat 40, the inboard bead seat 48, and the inboard bead seat retaining flange 60.

The preform hoop 109 is then subjected to a series of roll forming operations utilizing tools to shape the preform hoop 109 in a direction about the wheel axis X in steps 208, 210, 212. These operations 208, 210, and 212 are used to obtain the contoured shape of the rim 14 as shown in FIGS. 5 and 6. A series of roll forming operations are utilized since a single operation will submit too much stress on the preform hoop 109 in a single pass. Although three operations 208, 210, 212 are shown, any suitable number of operations can be performed. The rim 14 can then be secured to the wheel disc 12, such as by a weld, in step 214, thereby producing the finished wheel 10.

As can be understood, the specific numbers, ranges, dimensions and/or percentages disclosed herein can be other than illustrated and described if so desired.

The principle and mode of operation of this invention have been explained and illustrated in its preferred embodiments. However, it must be understood that this invention may be practiced otherwise than as specifically explained and illustrated without departing from its spirit or scope.

What is claimed is:

1. A vehicle wheel comprising:
an annular rim defining an axis and inboard and outboard sides, the rim including:
an outboard bead seat;
an inboard bead seat;
an outboard well flank connected to the outboard bead seat and extending radially inwardly and towards the inboard side of the rim;
an inboard well flank connected to the inboard bead seat and extending radially inwardly and towards the outboard side of the rim; and
a well portion defined between the outboard and inboard well flanks, wherein the well portion is formed by a plurality of curved and straight portions linked together, wherein the well portion has at least three transition portions having varying thickness cross-sectional profiles; and
a wheel disc secured to the rim, wherein the wheel disc includes a hub located centrally within the wheel disc and having a plurality of bolt holes formed therein.

2. The vehicle wheel of claim 1, wherein the vehicle wheel is a commercial vehicle wheel.

3. The vehicle wheel of claim 1, wherein the rim is produced by forming a metallic hoop.

4. The vehicle wheel of claim 2, wherein the rim is formed into a final desired shape by a flow forming process.

5. The vehicle wheel of claim 1, wherein the well portion has a first transition portion increasing in thickness in the direction from the outboard side to the inboard side.

6. The vehicle wheel of claim 5, wherein the well portion includes a second transition portion decreasing in thickness in the direction from the outboard side to the inboard side.

7. The vehicle wheel of claim 6, wherein the second transition portion includes a plurality of interconnected curved portions.

8. The vehicle wheel of claim 6, wherein the well portion includes a straight cylindrical portion disposed between the first and second transition portions.

9. The vehicle wheel of claim 6, wherein the well portion includes a third transition portion increasing in thickness in the direction from the outboard side to the inboard side.

10. The vehicle wheel of claim 9, wherein the well portion includes a curved portion disposed between the second and third transition portions.

11. The vehicle wheel of claim 9, wherein the well portion includes a fourth transition portion decreasing in thickness in the direction from the outboard side to the inboard side.

12. The vehicle wheel of claim 11, wherein the fourth transition portion has a curved shape.

13. A commercial vehicle wheel comprising:
a wheel disc secured to the rim, wherein the wheel disc includes a hub located centrally within the wheel disc and having a plurality of bolt holes formed therein; and
an annular rim secured to the disc, wherein the rim defines an axis and inboard and outboard sides, the rim including:
an outboard bead seat;
an inboard bead seat;
an outboard well flank connected to the outboard bead scat and extending radially inwardly and towards the inboard side of the rim;
an inboard well flank connected to the inboard bead seat and extending radially inwardly and towards the outboard side of the rim; and
a well portion defined between the outboard and inboard well flanks, wherein the well portion includes:
a first transition portion increasing in thickness in the direction from the outboard side to the inboard side;
a second transition portion decreasing in thickness in the direction from the outboard side to the inboard side;
a straight cylindrical portion disposed between the first and second portions;
a third transition portion increasing in thickness in the direction from the outboard side to the inboard side;
a curved portion disposed between the second and third transition portions;
a fourth transition portion decreasing in thickness in the direction from the outboard side to the inboard side.

14. The commercial vehicle wheel of claim 13, wherein the second transition portion includes a plurality of interconnected curved portions.

15. The commercial vehicle wheel of claim 13, wherein the fourth transition portion has a curved shape.

16. A method of forming a wheel rim comprising the steps of:
(a) providing a blank;
(b) forming the blank into a hoop defining a cylindrically shaped inner surface and a cylindrically shaped outer surface;
(c) flow forming one of the inner and outer surfaces of the hoop to create at least three transition portions having a varying thickness cross-sectional profile; and
(d) subsequently to step (c), performing at least one rolling operation on the hoop to form an outboard bead seat, an outboard well flank, an inboard bead seat, an inboard well flank, and a contoured well portion disposed between the outboard and inboard well flanks, wherein the well portion includes at least three transition portions having varying thickness cross-sectional profiles derived from the flow forming process of step (c), thereby forming the wheel rim.

17. The method of claim 16 further comprising the steps of:
(e) providing a wheel disc having a hub located centrally within the wheel disc and having a plurality of bolt holes formed therein; and
(f) securing the wheel disc to the wheel rim.

18. The method of claim 16, wherein in step (c) a flow forming operation is performed on the outer surface of the hoop to form a plurality of transition points where changes in the thickness of the hoop occur.

19. The method of claim 18, wherein the hoop defines an outboard side and an inboard side, and wherein in step (c) the flow forming operation performed on the outer surface of the hoop forms a plurality of first portions having a decreasing thickness in the direction from the outboard side to the inboard side.

20. The method of claim 19, wherein the flow forming operation performed on the outer surface of the hoop forms a plurality of second portions having an increasing thickness in the direction from the outboard side to the inboard side.

21. A method of forming a vehicle wheel comprising the steps of:
(a) providing a blank;
(b) forming the blank into a hoop defining a cylindrically shaped inner surface and a cylindrically shaped outer surface, wherein the hoop defines an outboard side and an inboard side;
(c) flow forming the outer surface of the hoop to form a plurality of transition points where changes in the thickness of the hoop occur such that the flow forming forms a plurality of first portions having a decreasing thickness in the direction from the outboard side to the inboard side, and forms a plurality of second portions having an increasing thickness in the direction from the outboard side to the inboard side;
(d) subsequently to step (c), performing at least one rolling operation on the hoop to form an outboard bead seat, an outboard well flank, an inboard bead seat, an inboard well flank, and a contoured well portion disposed between the outboard and inboard well flanks, wherein the wheel well portion includes transition portions having varying cross-sectional profiles derived from the flow forming process of step (c);
(e) providing a wheel disc; and
(f) securing the wheel disc to the wheel rim, thereby forming the vehicle wheel.
